(19) United States
(12) Patent Application Publication
(10) Pub. No.: US 2002/0171180 A1
(43) Pub. Date: Nov. 21, 2002

(54) Method of making a catheter balloon

(75) Inventor: Murthy V. Simhambhatla, San Jose, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(73) Assignee: Advanced Cardiovascular Systems, Inc

(21) Appl. No.: 09/862,223

(22) Filed: May 21, 2001

(51) Int. Cl. B29C 49/18

(52) U.S. Cl. 264/530

(57) ABSTRACT

A method of forming an expandable member for a medical device, and particularly a balloon for a catheter, in which extruded tubing is first expanded in a continuous or a semi-continuous process to form expanded tubing, and then the expanded tubing is further expanded in a balloon mold to form the catheter balloon. The method generally includes expanding a long length of tubing from a first inner and outer diameter to a second larger inner and outer diameter, to form expanded tubing having an expanded intermediate diameter, and processing the expanded tubing to form a plurality of expanded intermediate diameter tube segments, each segment having a length significantly shorter than the length of the expanded tubing. One of the segments is then placed in an inner chamber of a balloon mold, and expanded in the balloon mold to form a balloon for a catheter.

### BACKGROUND OF THE INVENTION

This invention generally relates to medical devices, and particularly to balloon catheters.

In percutaneous transluminal coronary angioplasty (PTCA) procedures, a guiding catheter is advanced until the distal tip of the guiding catheter is seated in the ostium of a desired coronary artery. A guidewire, positioned within an inner lumen of an dilatation catheter, is first advanced out of the distal end of the guiding catheter into the patient's coronary artery until the distal end of the guidewire crosses a lesion to be dilated. Then the dilatation catheter having an inflatable balloon on the distal portion thereof is advanced into the patient's coronary anatomy, over the previously introduced guidewire, until the balloon of the dilatation catheter is properly positioned across the lesion. Once properly positioned, the dilatation balloon is inflated with liquid one or more times to a predetermined size at relatively high pressures (e.g. greater than 8 atmospheres) so that the stenosis is compressed against the arterial wall and the wall expanded to open up the passageway. Generally, the inflated diameter of the balloon is approximately the same diameter as the native diameter of the body lumen being dilated so as to complete the dilatation but not overexpand the artery wall. Substantial, uncontrolled expansion of the balloon against the vessel wall can cause trauma to the vessel wall. After the balloon is finally deflated, blood flow resumes through the dilated artery and the dilatation catheter can be removed therefrom.

In such angioplasty procedures, there may be restenosis of the artery, i.e. reformation of the arterial blockage, which necessitates either another angioplasty procedure, or some other method of repairing or strengthening the dilated area. To reduce the restenosis rate and to strengthen the dilated area, physicians frequently implant an intravascular prosthesis, generally called a stent, inside the artery at the site of the lesion. Stents may also be used to repair vessels having an intimal flap or dissection or to generally strengthen a weakened section of a vessel. Stents are usually delivered to a desired location within a coronary artery in a contracted condition on a balloon of a catheter which is similar in many respects to a balloon angioplasty catheter, and expanded to a larger diameter by expansion of the balloon. The balloon is deflated to remove the catheter and the stent left in place within the artery at the site of the dilated lesion.

In the design of catheter balloons, balloon characteristics such as strength, flexibility and compliance must be tailored to provide optimal performance for a particular application. Angioplasty balloons preferably have high strength for inflation at relatively high pressure, and high flexibility and softness for improved ability to track the tortuous anatomy and cross lesions in the uninflated state. The balloon compliance is chosen so that the balloon will have a desired amount of expansion during inflation. Compliant balloons, for example balloons made from materials such as polyethylene, exhibit substantial stretching upon application of internal pressure. Noncompliant balloons, for example balloons made from materials such as PET, exhibit relatively little stretching during inflation, and therefore provide controlled radial growth in response to an increase in inflation pressure within the working pressure range.

For many applications, intravascular catheter balloons should be substantially noncompliant once expanded to a working diameter. Further, catheter balloons should also be formed from relatively strong materials to provide a balloon having a sufficiently high rupture pressure that it can withstand the pressures necessary for various procedures without failing.

It would be a significant advance to provide a catheter balloon, with improved compliance, rupture pressure, and fatigue performance.

### SUMMARY OF THE INVENTION

This invention is directed to a method of forming an expandable polymeric member for a medical device, and particularly a balloon for a catheter, in which extruded polymer tubing is first expanded in a continuous or a semi-continuous process to form expanded tubing, and then the expanded tubing is further expanded in a balloon mold to form the catheter balloon. The method generally includes expanding a long length of tubing from a first outer diameter to an expanded intermediate outer diameter larger than the first diameter, to form expanded tubing having a length and an expanded intermediate diameter, and processing the expanded tubing to form a plurality of expanded intermediate diameter tube segments, each segment having a length significantly shorter than the length of the expanded tubing. One of the segments is then placed in an inner chamber of a balloon mold, and expanded in the balloon mold to a third outer diameter larger than the intermediate diameter, to form a balloon for a catheter. In a presently preferred embodiment, the polymeric material is comprises a polyester copolymer, such Hytrel®, available from Dupont, or Arnitel®, available from DSM Engineering Plastics. The method provides for improved manufacturability of a balloon having improved compliance, rupture pressure, and fatigue performance.

In one embodiment, the extruded tubing is expanded to form the expanded intermediate diameter tubing in a continuous process, which in a presently preferred embodiment comprises moving the tubing through an expansion die, and expanding the tubing in the expansion die by pressurizing the tubing and optionally applying axial tension. A length of tubing is typically fed or drawn through the expansion die such that the tubing moves through the die in a continuous manner. In another embodiment, the tubing is expanded in a semi-continuous process, which in a presently preferred embodiment comprises placing a length of tubing in an inner chamber of a mold and expanding the tubing in the mold to form the expanded tubing.

The expanded tubing thus formed by the continuous or semi-continuous expansion process then is processed to form a plurality of segments, as for example by cutting the tubing to form multiple shorter lengths of expanded tubing. Each segment is further expanded in a balloon mold to a final outer diameter to form the catheter balloon.

The method provides a balloon having a higher blow up ratio (BUR) than would otherwise be possible if the balloon was formed by expanding the extruded tubing in a single step to the final balloon outer diameter. The BUR, which is the ratio of the balloon outer diameter to the extruded tubing inner diameter, influences balloon characteristics. A high BUR typically provides a balloon having lower balloon compliance, higher burst strength, and improved fatigue performance. However, forming a high BUR balloon in a single step can often lead to rupture of the tubing before the balloon is fully formed. The maximum BUR, which is dependent on factors including the polymeric material used to form the tubing, is limited in balloons formed by single step expansion processes. EP 878209 discloses a method for forming a catheter balloon for a dilatation catheter, including the steps of expanding a tube in a preconditioned mold to form a parison, and expanding the parison in a balloon mold to form a balloon. EP 878209 does not disclose or suggest a continuous or semi-continuous process for expanding a length of tubing having a length significantly longer than the length of individual segments of the tubing which are further expanded to form individual balloons.

A balloon formed according to a method of the invention can be secured to a catheter shaft using conventional methods, to form a balloon catheter. A balloon catheter having a balloon formed according to a method of the invention generally comprises an elongated shaft having a proximal end, a distal end, and an inflation lumen therein, with the balloon on a distal shaft section having an interior in fluid communication with the inflation lumen. The balloon catheter can be used for a variety of applications including PTCA, stent delivery, and the like.

Although discussed primarily in terms forming a balloon for a balloon catheter, the invention should be understood to include other expandable components for medical devices, and particularly intracorporeal devices for a therapeutic or diagnostic purpose, such as stent covers and vascular grafts formed according to the method of the invention.

A method of the invention provides a continuous or semi-continuous process for expanding tubing which is used to form a balloon having a high BUR. The method thus provides for improved manufacture of a balloon having lower compliance, high rupture pressure, and improved fatigue performance as compared to an otherwise similar balloon formed by a single expansion process. These and other advantages of the invention will become more apparent from the following detailed description when taken in conjunction with the accompanying exemplary drawings.

### BRIEF DESCRIPTION OF THE DRAWINGS

FIG. 1 is an elevational view, partially in section, of a balloon catheter for delivering a stent, having a balloon formed according to a method that embodies features of the invention.

FIG. 2 is a longitudinal cross sectional view of an extruded tube used to form a balloon according to a method that embodies features of the invention.

FIG. 3 is a transverse cross-section of the tubing shown in FIG. 2, taken at line 3-3.

FIG. 4 is a longitudinal cross sectional view of the extruded tube shown in FIG. 2, after being expanded to form expanded intermediate diameter tubing, according to a method that embodies features of the invention.

FIG. 5 is a transverse cross-section of the tubing shown in FIG. 4, taken at line 5-5.

FIG. 6 is a longitudinal cross sectional view of the expanded intermediate diameter tube segment after being necked to form a preform, according to a method that embodies features of the invention.

FIG. 7 is a transverse cross-section of the tubing shown in FIG. 6, taken at line 7-7.

FIG. 8 illustrates an expander die apparatus used to form expanded intermediate diameter tubing according to a continuous process which embodies features of the invention.

FIG. 9 is a longitudinal cross sectional view of a mold used to form expanded intermediate diameter tubing according to a semi-continuous process which embodies features of the invention.

FIG. 10 is a longitudinal cross sectional view of a balloon mold having an expanded intermediate diameter tube segment expanded therein to form a balloon.

FIG. 11 is a transverse cross sectional view of the mold and balloon therein shown in FIG. 10, taken along line 11-11.

### DETAILED DESCRIPTION OF THE INVENTION

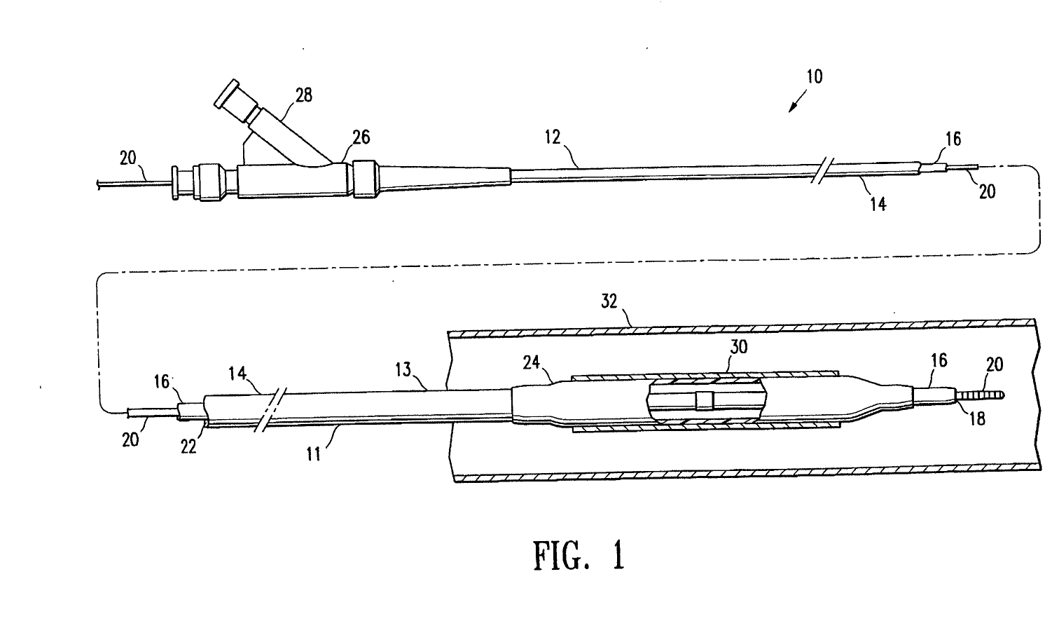

FIG. 1 illustrates an over-the-wire type stent delivery balloon catheter 10 embodying features of the invention. Catheter 10 generally comprises an elongated catheter shaft 12 having an outer tubular member 14 and an inner tubular member 16. Inner tubular member 14 defines a guidewire lumen 18 adapted to slidingly receive a guidewire 20. The coaxial relationship between outer tubular member 14 and inner tubular member 16 defines annular inflation lumen 22. An inflatable balloon 24 disposed on a distal section of catheter shaft 12 having a proximal end sealingly secured to the distal end of outer tubular member 14 and a distal end sealingly secured to the distal end of inner tubular member 16 so that its interior is in fluid communication with inflation lumen 22. An adapter 26 at the proximal end of catheter shaft 12 is configured to direct inflation fluid through arm 28 into inflation lumen 22 and provide access to guidewire lumen 18. In the embodiment illustrated in FIG. 1, an expandable stent 30 is mounted on balloon 24. The distal end of catheter may be advanced to a desired region of a patient's body lumen 32 in a conventional manner and balloon 24 may be inflated to expand stent 30, seating it in the lumen.

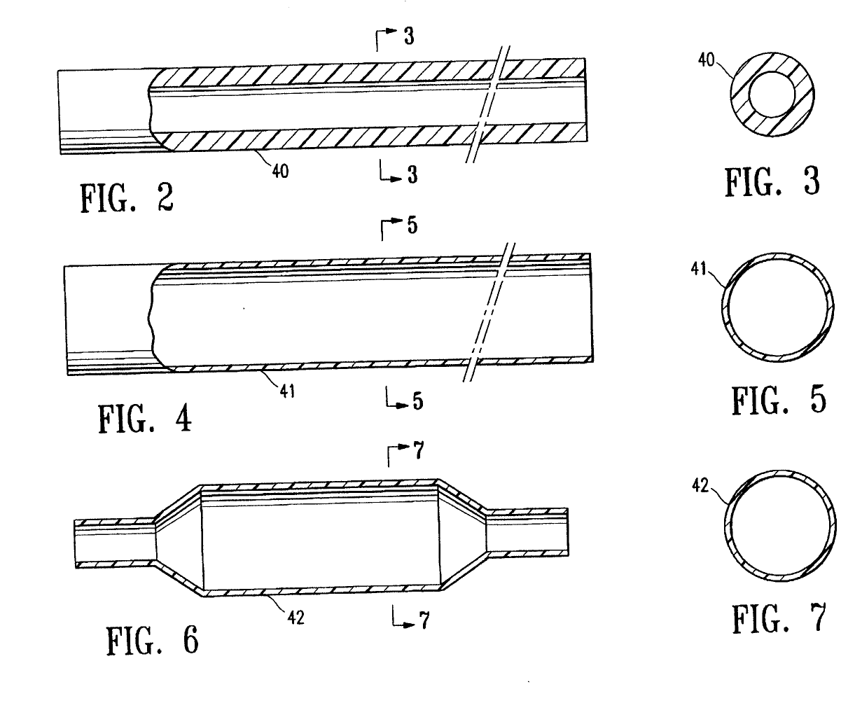

In accordance with the invention, balloon 24 is made in a multiple step expansion process. A long length of extruded tubing 40, illustrated in FIGS. 2 and 3, is first expanded in a continuous or semi-continuous process from a first diameter to an intermediate diameter to form expanded tubing 41, illustrated in FIGS. 4 and 5, having an expanded intermediate diameter. The expanded tubing 41 is then cut or otherwise processed to form a plurality of intermediate diameter tube segments 42 (see FIGS. 6 and 7). Each tube segment 42 can then be expanded in a balloon mold to a third diameter to form an individual balloon. The expansions are performed at an elevated temperature which is preferably greater than the glass transition temperature of the polymer but less than the crystalline melting point thereof. In the embodiment illustrated in FIG. 6, the expanded intermediate diameter tube segment 42 is formed into a preform before being expanded in the balloon mold, by reducing the diameter of at least one of the ends of the expanded intermediate diameter tube segment 42. FIG. 6 illustrates a preform having both ends necked to reduce the diameter thereof so that the preform can fit into the inner chamber of a balloon mold.

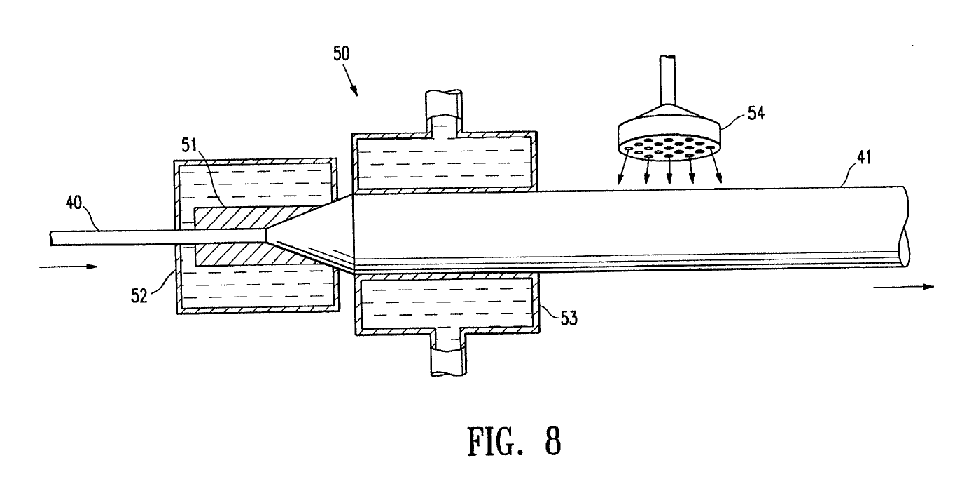

In a first embodiment of the invention, the tubing 40 is expanded in a continuous process to form expanded tubing 41. The extruded tubing is heated to an elevated temperature which is above the glass transition temperature of the polymer forming the extruded tubing, but less than the crystalline melting point of the polymer. By applying internal pressure, and optionally axial tension, the tubing is expanded to a diameter greater than the original diameter of the extruded tubing. The expanded tubing is cooled to a temperature below the glass transition temperature of the polymer to fix the dimensions thereof. FIG. 8 illustrates a method of continuously expanding the extruded tubing 40, comprising expanding a long length of tubing in an expander apparatus 50. The process comprises expanding the extruded tubing 40 using an expansion die 50 immersed in a tank 52 of heated glycerol, fixing the dimensions with a water-cooled die 53, and washing off the glycerol with a water spray 54. As the tubing 40 is moving through the expansion die 51 and out the outlet thereof, it is subjected to heat and pressure to expand the tubing from a first inner and outer diameter to a second larger inner and outer diameter. The glycerol serves as an immersion fluid for heating the expansion die 51 and extruded polymer tubing 40, and also serves to lubricate the interface between the extruded polymer tubing 40 and the expansion and cooling dies 51/53. The apparatus 50 provides for reduced residence time of the polymeric tubing at elevated temperatures prior to expansion thereof. The extruded tubing 40 is moved through the expander apparatus 50 in a continuous manner, such that it is fed into the inlet of the expansion die and out the outlet of the cooling die. Thus, a long length of tubing 40, having a length significantly longer than the length of balloon 24, can be expanded by expansion apparatus 50 to form expanded tubing 41. The length of tubing 40 fed through expansion apparatus 50 is typically about 300 to about 1000 meters. The expanded tubing 41 thus formed has a uniform expanded outer diameter, unlike expanded tubing preblown in a conventional balloon mold having tapered sections therein. Alternatively, this process can be performed using the kind of tubing expander described in U.S. Pat. No. 3,086,242 for the production of tubing with a plastic memory, or an expansion die used for expansion of heat-shrink tubing, although such expander apparatus are not preferred where the apparatus is expensive to build, difficult to maintain, and not conducive to the reduction of the residence time of the polymer tubing at elevated temperatures prior to expansion.

The expanded tubing 41 is then processed to form a plurality of expanded intermediate diameter tube segments 42, each segment having a length significantly shorter than the length of the expanded tubing 41. The expanded tubing 41 is preferably processed by cutting into short tube segments 42, however, it can be processed by a variety of methods. The length of segment 42 is typically about 60 to about 90 centimeters, to form a balloon having a working length of about 1 to about 4 centimeters. An expanded intermediate diameter tube segment 42 is illustrated in FIG. 6, after the ends of the segment are necked to a smaller outer diameter using a hot die and applying tension. The necked ends of the segment 42 form the shaft sections of the balloon 24 at either end of the working length of the balloon 24. Tubing segment 42 thus formed with necked ends is placed into the inner chamber of a balloon mold 56, and expanded under heat and pressure to form balloon 24, as shown in FIG. 10, illustrating a longitudinal cross section of balloon mold 56 after the necked segment 42 is expanded therein to form balloon 24. Balloon mold 56 has a conventional balloon mold inner chamber having a first section 57 configured to form the working length of the balloon 24, tapered sections 58 at either end of the first section 57, and end sections 59 adjacent the tapered sections 58. Preferably, axial tension is applied to the preform 42 during blow molding into balloon 24. In one embodiment, the balloon 24 thus formed has proximal and distal shaft sections having a wall thickness not greater than the wall thickness of the working length of the balloon.

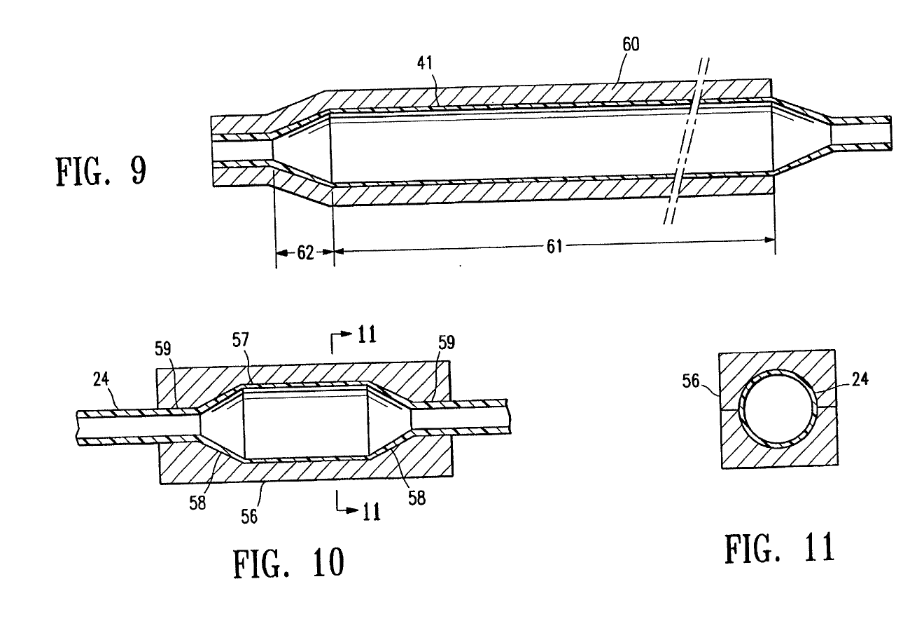

FIG. 9 illustrates an alternative embodiment in which a section of the extruded tubing 40 is expanded in a semi-continuous process, comprising placing the extruded tubing 40 in an inner chamber of a mold 60 and expanding the tubing in the mold 60 to form the expanded tubing 41. The mold 60 inner chamber has a first, large inner diameter section 61 with an inner diameter configured to form the expanded tubing 41 having an expanded intermediate diameter, and with a length which is significantly longer than a length of each individual expanded intermediate diameter tube segment 42 formed from the expanded tubing 41. The length of the first section 61 of the mold 60 is typically about 1 to about 3 meters. In the embodiment illustrated in FIG. 9, the mold 60 has a single taper 62 unlike a balloon mold, and the expanded tubing 41 thus formed in mold 60 has only one tapered section. In a presently preferred embodiment, the second, tapered section 62 of the mold has a gradual taper of about 10° to about 45°. In a presently preferred embodiment, the tubing 40 is expanded in the mold 60 using a translating heating nozzle (not shown) to heat the tubing in the mold to a temperature above the glass transition temperature and below the melting point, as an inflating pressure is applied within the tubing 40, and preferably as axial tension is applied to the tubing 40. The thus expanded tubing 41 is then processed into a plurality of expanded intermediate diameter tube segments and then blown into balloon 24 in balloon mold 56, as discussed above in relation to the embodiment of FIG. 8.

The methods illustrated in FIGS. 8 and 9, can be used to form a balloon 24 having a larger blow up ratio than a balloon formed by expanding tubing in a single step to a final balloon diameter. The BUR of the balloon 24 formed according to the method of the invention is typically about 5 to about 8, preferably about 6 to about 7.5. In one embodiment, the balloon 24 has a compliance less than a compliance of a balloon formed by expanding tubing in a single step to a final balloon outer diameter. The compliance of balloon 24 is about 0.01 to about 0.05 mm/atm over an inflation pressure range of about 6 to 8 to about 14 to 18 atm, depending on the polymeric material used to form balloon 24. Preferably, the balloon 24 is a low compliant balloon with a compliance of not greater than about 0.01 to about 0.03 mm/atm. In a presently preferred embodiment, the balloon material is a copolyester with a polybutylene terephthalate hard segment, such as Hytrel®, available from Dupont, or Arnitel®, available from DSM Engineering. The copolyester balloon preferably is formed with a BUR of about 6 to about 7.5, and has a compliance of about 0.01 to about 0.03 mm/atm. However, a variety of suitable materials can be used to form balloon 24, including polyamides such as nylon 12, and polyamide block copolymers and polyurethane block copolymers.

Extruded tubing 40 typically has an outer diameter of about 0.032 to about 0.037 inches, and an inner diameter of about 0.016 to about 0.020 inches, for a 3 mm outer diameter balloon, with the tubing dimensions scaling roughly linearly with the balloon outer diameter. Expanded intermediate diameter tubing 41 typically has an outer diameter of about 3 to about 4.5 times the inner diameter of the extruded tubing. The balloon 24 working length has an inflated working outer diameter of about 6 to about 7.5 times the inner diameter of the extruded tubing.

The dimensions of catheter 10 are determined largely by the size of the balloon and guidewires to be employed, catheter type, and the size of the artery or other body lumen through which the catheter must pass or the size of the stent being delivered. Typically, the outer tubular member 14 has an outer diameter of about 0.025 to about 0.04 inch (0.064 to 0.10 cm), usually about 0.037 inch (0.094 cm), the wall thickness of the outer tubular member 14 can vary from about 0.002 to about 0.008 inch (0.0051 to 0.02 cm), typically about 0.003 to 0.005 inch (0.0076 to 0.013 cm). The inner tubular member 16 typically has an inner diameter of about 0.01 to about 0.018 inch (0.025 to 0.046 cm), usually about 0.016 inch (0.04 cm), and wall thickness of 0.004 to 0.008 inch (0.01 to 0.02 cm). The overall length of the catheter 10 may range from about 100 to about 150 cm, and is typically about 135 cm. Preferably, balloon 24 may have a length about 0.5 cm to about 4 cm and typically about 2 cm, and an inflated working diameter of about 1 to about 8 mm.

Inner tubular member 16 and outer tubular member 14 can be formed by conventional techniques, for example by extruding and necking materials already found useful in intravascular catheters such a polyethylene, polyvinyl chloride, polyesters, polyamides, polyimides, polyurethanes, and composite materials. The various components may be joined by heat bonding or use of adhesives.

While the present invention is described herein in terms of certain preferred embodiments, those skilled in the art will recognize that various modifications and improvements may be made to the invention without departing from the scope thereof. For example, in the embodiment illustrated in FIG. 1, the catheter is over-the-wire stent delivery catheter. However, one of skill in the art will readily recognize that the balloons of this invention may also be used with other types of intravascular catheters, such as rapid exchange dilatation catheters having a distal guidewire port and a proximal guidewire port and a short guidewire lumen extending between the proximal and distal guidewire ports in a distal section of the catheter. Moreover, although individual features of one embodiment of the invention may be discussed herein or shown in the drawings of the one embodiment and not in other embodiments, it should be apparent that individual features of one embodiment may be combined with one or more features of another embodiment or features from a plurality of embodiments.

What is claimed is:

1. A method of making a catheter balloon, comprising:
a) expanding a length of polymer tubing from a first outer diameter to a second, expanded intermediate outer diameter larger than the first diameter, to form expanded tubing having a length;
b) processing the expanded tubing to form a plurality of expanded intermediate diameter tube segments, each segment having a length significantly shorter than the length of the expanded tubing;
c) placing one of the segments in an inner chamber of a balloon mold; and
d) expanding the segment to a third outer diameter in the balloon mold, to form a balloon for a catheter.

2. The method of claim 1 wherein expanding the tubing is a continuous process comprising moving the tubing through an expansion die in a continuous manner, and expanding the tubing in the expansion die by heating and pressurizing the tubing to form the expanded tubing.

3. The method of claim 2 wherein the tubing is expanded in the expansion die such that the expanded tubing has a uniform expanded outer diameter.

4. The method of claim 2 wherein (b) comprises forming at least about 1000 to about 5000 segments from the length of the expanded tubing.

5. The method of claim 1 wherein expanding the tubing is a semi-continuous process comprising placing the tubing in an inner chamber of a mold, wherein the inner chamber of the mold has a large inner diameter section having an inner diameter configured to form the expanded tubing and having a length which is significantly longer than a length of each individual expanded intermediate diameter tube segment formed from the expanded tubing, and expanding the tubing in the mold to form the expanded tubing.

6. The method of claim 5 wherein the inner chamber of the mold has a single tapered section.

7. The method of claim 5 wherein (b) comprises forming at least about 2 to about 3 segments from the length of the expanded tubing.

8. The method of claim 1 wherein the balloon mold has a large inner diameter section configured to form a working length of the balloon, tapered sections at either end of the large inner diameter section, and end sections adjacent the tapered sections, and including before (c), reducing the outer diameter of at least one of a proximal end section and a distal end section of the expanded intermediate diameter tube segment.

9. The method of claim 8 wherein reducing the diameter of the proximal or distal end section comprises necking at least one end of the expanded intermediate diameter tube segment.

10. The method of claim 8 wherein axial tension is applied to the segment at an elevated temperature during expansion thereof in the balloon mold, and wherein the balloon has proximal and distal shaft sections having a wall thickness not greater than the wall thickness of a working length of the balloon.

11. The method of claim 1 wherein the segment is expanded to form a balloon having a compliance less than a compliance of a balloon formed by expanding extruded tubing in a single step to a final balloon outer diameter.

12. The method of claim 1 wherein the segment is expanded to form a balloon having a blow up ratio greater than a blow up ratio of a balloon formed by expanding extruded tubing in a single step to a final balloon outer diameter.

13. The method of claim 1 wherein processing the expanded tubing to form the plurality of segments comprises cutting the expanded tubing, and wherein each segment produced thereby has a uniform outer diameter along the length of the segment.

14. The method of claim 1 wherein axial tension is applied to the tubing during expansion thereof to form the expanded tubing.

15. The method of claim 1 wherein the second, expanded intermediate outer diameter is about 3 to about 4.5 times an inner diameter of the extruded tubing.

16. The method of claim 1 wherein the tubing comprises a copolyester polymeric material, and the balloon is formed with a blow-up-ratio of about 6 to about 7.5.

17. A method of making a catheter balloon, comprising:
a) expanding a length of copolyester polymer tubing from a first outer diameter to a second, expanded intermediate outer diameter larger than the first diameter, to form expanded tubing having a length;
b) processing the expanded tubing to form a plurality of expanded intermediate diameter tube segments, each segment having a length significantly shorter than the length of the expanded tubing;
c) placing one of the segments in an inner chamber of a balloon mold; and
d) expanding the segment to a third outer diameter in the balloon mold, to form a catheter balloon having a blow-up-ratio of about 5 to about 8.

18. A method of making a catheter balloon, comprising:
a) expanding tubing having a first inner diameter and outer diameter to a second, expanded intermediate outer diameter greater than the first outer diameter to form expanded tubing having a length;
b) processing the expanded tubing to form a plurality of expanded intermediate diameter tube segments, each segment having a length significantly shorter than the length of the expanded tubing;
c) reducing the outer diameter of at least one of a proximal end and a distal end of the expanded intermediate diameter tube segment to form a preform;
d) placing the preform in an interior chamber of a balloon mold having a large inner diameter section, tapered sections at either end of the large diameter section, and end sections adjacent the tapered sections, the end sections having an inner diameter which is greater than the reduced outer diameter of the proximal and distal ends of the preform; and
e) expanding the preform in the balloon mold to form a balloon for a catheter.
